(19) United States
(12) Patent Application Publication
(10) Pub. No.: US 2004/0104321 A1
(43) Pub. Date: Jun. 3, 2004

(54) Adjustable connector for I.V. poles and medical devices

(76) Inventors: Thomas R. Marsolais, St. Paul, MN (US); Mark Johnson, St. Paul, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/635,218

(22) Filed: Aug. 6, 2003

Related U.S. Application Data
(60) Provisional application No. 60/401,256, filed on Aug. 6, 2002.

(51) Int. Cl. F16B 1/00

(52) U.S. Cl. 248/229.1; 248/125.8

(57) ABSTRACT

Methods and devices for securing a medical apparatus to a patient-transportation device is disclosed, including extensible and telescoping poles with releasable mechanisms for securing i.v. poles to a wheelchair.

### RELATED APPLICATIONS

This application claims priority to provisional U.S. Patent Serial No. 60/401,256, filed Aug. 6, 2002, which is hereby incorporated herein by reference.

### BACKGROUND

Patients that stay in a hospital often require transportation from their hospital room to other rooms for testing, diagnostics, or exercise. This transportation sometimes takes the form of a wheelchair, gurney, or, in the case of children, a wagon. Many patients receive intravenous (i.v.) administration of fluids as part of their treatments.

The i.v. administration is preferably continuous to avoid the inconvenience of removing and reinserting i.v. needles from the patient. Thus the transportation of a patient is commonly performed while the i.v. administration continues. The poles that carry the bags of i.v. fluids, referred to as i.v. poles, are typically wheeled. The i.v. poles are thus held by the hospital staff member that is pushing or pulling the transport.

A staff member moving a patient that is connected to an i.v. pole is thus forced to use one hand to direct the i.v. pole and another hand to push the wheelchair. This is uncomfortable for the staff member and represents a hazard to the patient since control of the wheelchair is compromised. This situation also slows transportation since the staff member must walk more slowly while maneuvering with both the wheelchair and the i.v. pole.

### SUMMARY OF THE INVENTION

The Applicants have identified the difficulties in managing a transport and an i.v. pole or other medical device that requires movement with the patient's transport. These difficulties are addressed herein by providing a transporting pole that is easily fitted to the transport and to the i.v. pole. The transporting pole allows for the i.v. pole or medical device to be moved with the transport and preferably maintains the i.v. stand at a fixed position relative to the patient's transport so that the pole is moved with the patient's transport.

### BRIEF DESCRIPTION OF THE FIGURES

FIG. 1 depicts a perspective view of an embodiment of a transporting pole and latch.

FIG. 2 depicts a perspective view of an embodiment of a transporting pole and latch.

FIG. 3 depicts partial elevated views of various embodiments of a grip of a transporting pole.

FIG. 4A and 4B depict an elevated view of an embodiment in use with a wheelchair.

FIG. 5 depicts a front elevated view of an embodiment of the invention.

FIG. 6 depicts a plan view of the embodiment of the invention of FIG. 5.

FIG. 7 depicts a side view of an embodiment of the invention.

FIG. 8 depicts a plan view of an embodiment of the invention.

FIG. 9 depicts a side view of an embodiment of the invention.

FIG. 10 depicts a front elevated view of the embodiment of the invention of FIG. 9 as viewed from the perspective of line 10-10 therein.

FIG. 11 depicts an embodiment of the invention, with a gripping member being stored behind a wheelchair.

FIG. 12 depicts an embodiment of the invention.

### DETAILED DESCRIPTION OF THE PREFERRED EMBODIMENTS

A preferred embodiment of the invention is a transporting pole that has a main body and an extension that is connected thereto. The extension is joined to the main body so that the extension may be stowed when not in use. The extension is connected to a grip. The grip is adapted to grip a medical device, e.g., an i.v. pole. Fasteners are used to fasten the main body to the transport that carries a patient.

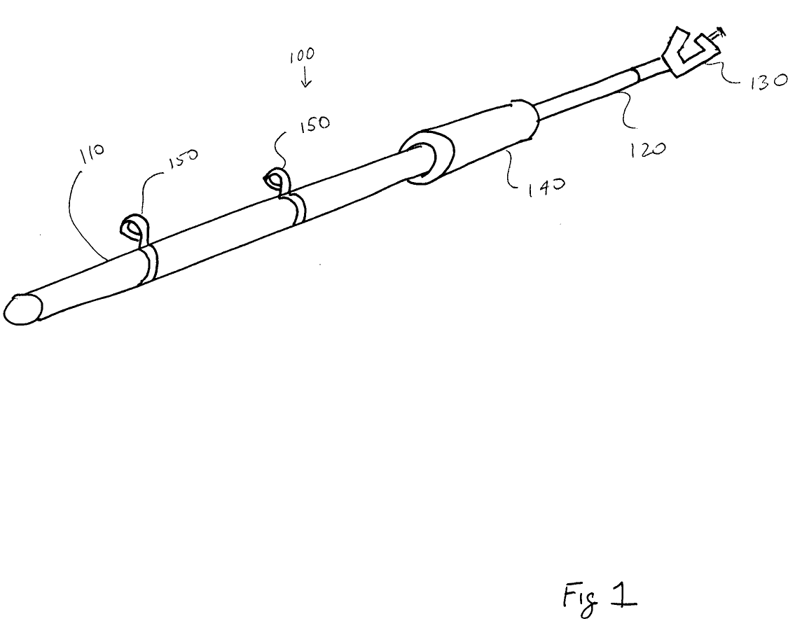

Referring to FIG. 1, transporting pole 100 has main body 110 and extension 120 that is received by main body 110 so that extension 120 may be stowed substantially within main body 110. Extension 120 is connected to grip 130. Holder 140 is positioned so that tightening the holder causes holder 140 to hold extension 120 in place relative to main body 110. Main body is attached to fasteners 150. In use, fasteners 150 are attached to a transport, e.g., a wheelchair. Extension 120 telescopically slides out of main body 110 to a desired length. Holder 140 is tightened to secure extension 120. A medical device, e.g., i.v. pole or gurney leg, is placed into grip 130 and bolt 132 is tightened, preferably hand-tight, to secure the medical device in grip 130.

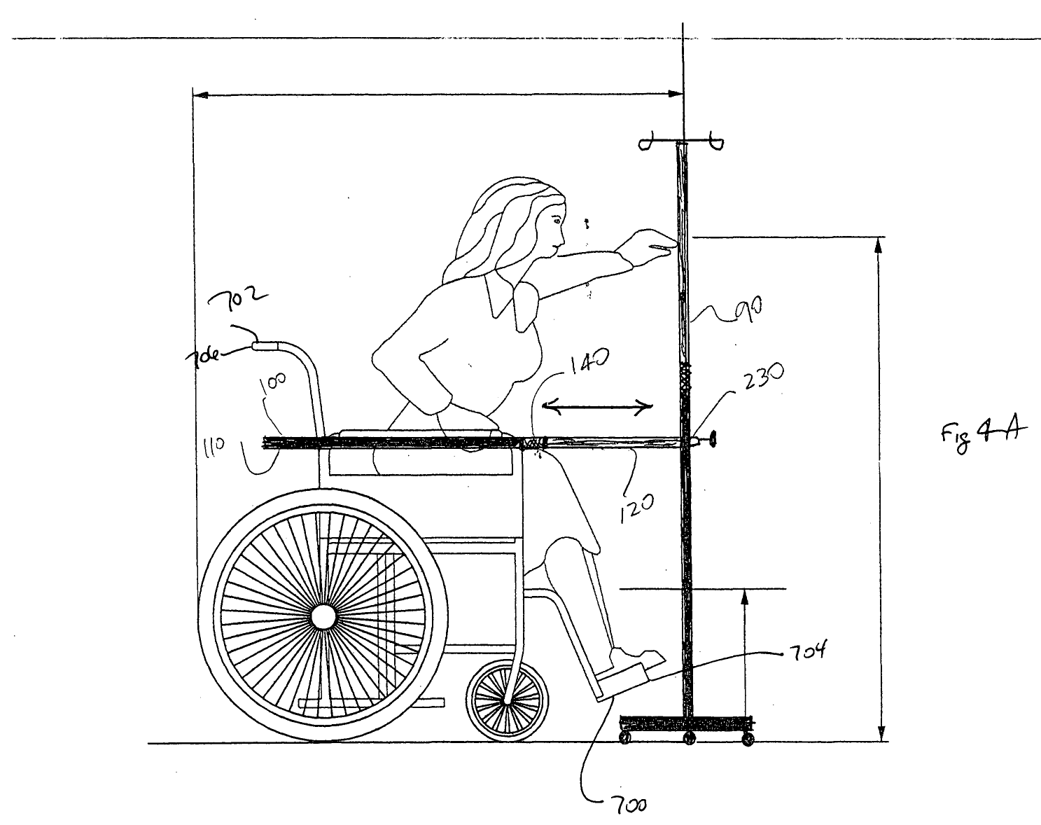

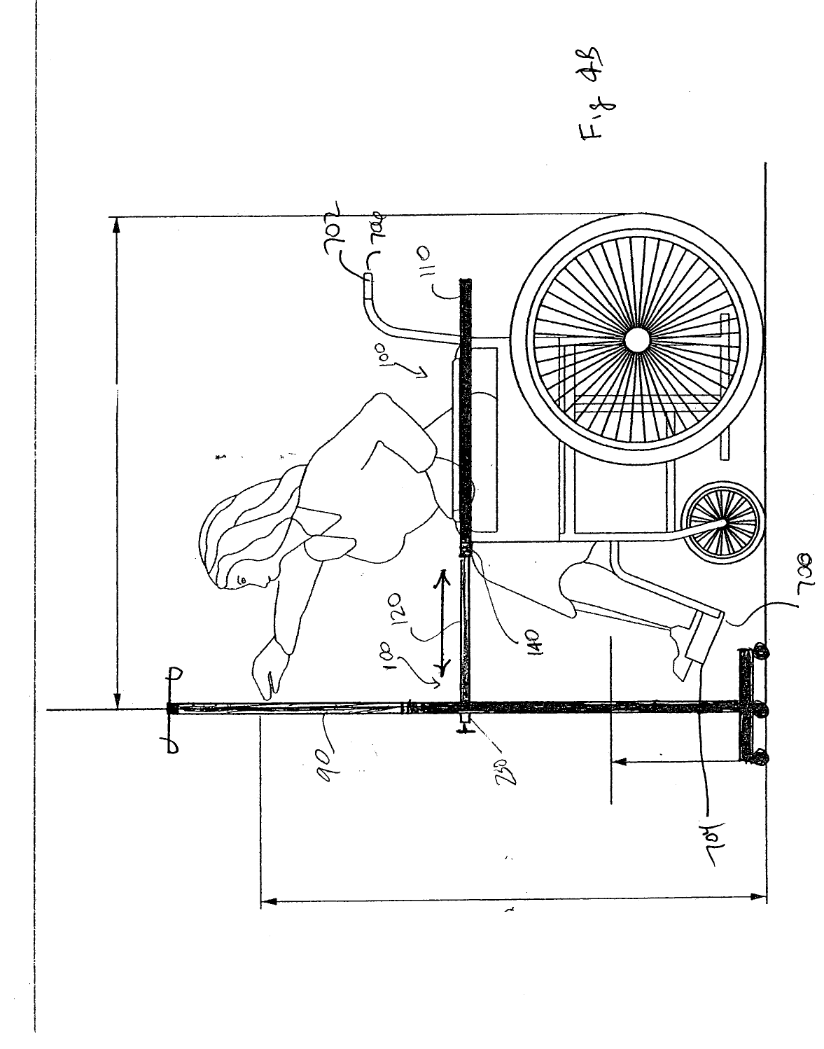

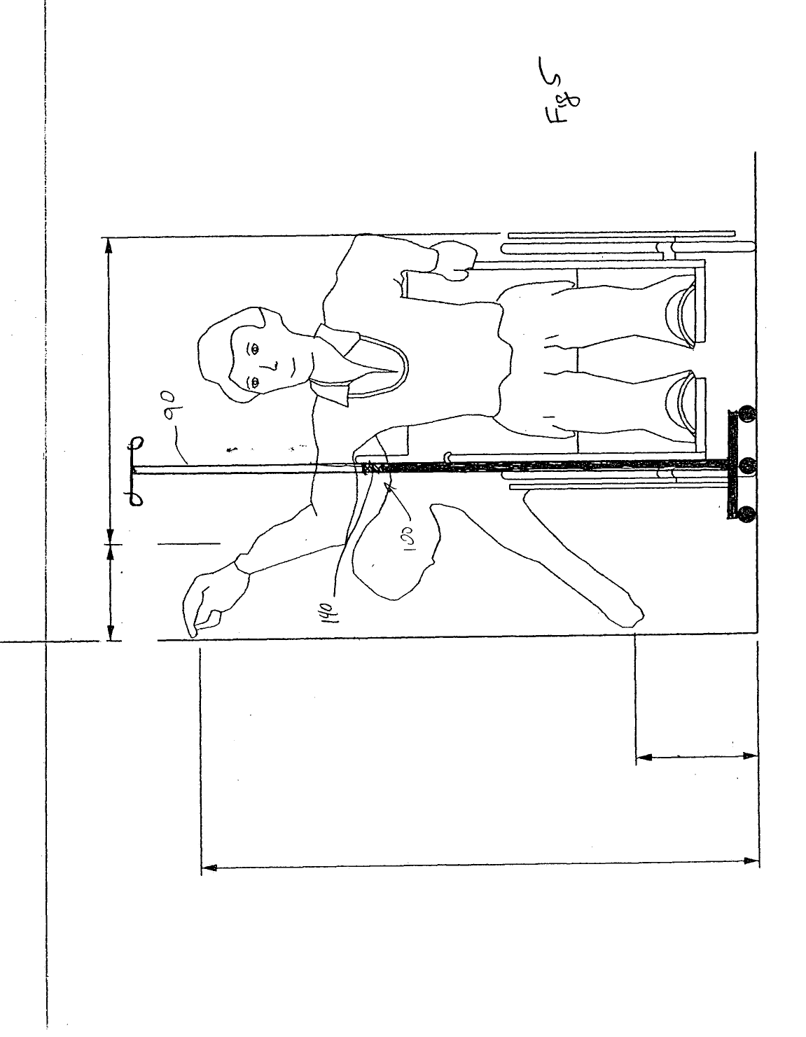

FIGS. 4A and 4B show this embodiment in place on a wheelchair. The extension is positioned so as to clear the patient's feet, which can be achieved on conventional wheelchairs by moving the i.v. pole to a comfortable arm's length (see Figure) and securing the extension and grip thereto. Wheelchair handle 702 and footrest 700 are depicted. Significantly, transporting pole 10 may be stowed with the length of the pole being less than the distance between end 706 of handle 702 and tip 704 of footrest 700. FIGS. 5 and 6 similarly show this embodiment in use. The i.v. pole is preferably positioned in front of one of the arms of the wheelchair so that the patient may readily move in and out of the wheelchair.

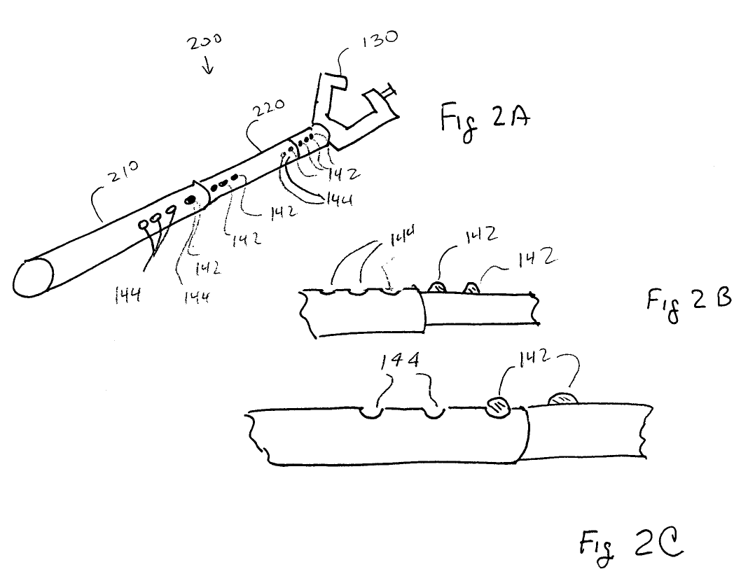

FIGS. 2A, 2B, and 2C show an alternative embodiment of the invention. The extension 220 is connected to main body 210 using pins 142 that are received by pin-slots 144. The pins may be depressed to allow their passage inside of main body 210 (FIGS. 2B-2C) but are biased upwardly so they move to an up position when received by pin-slots 144. The pins thus connect the main body 210 and extension 220 and prevent its rotation.

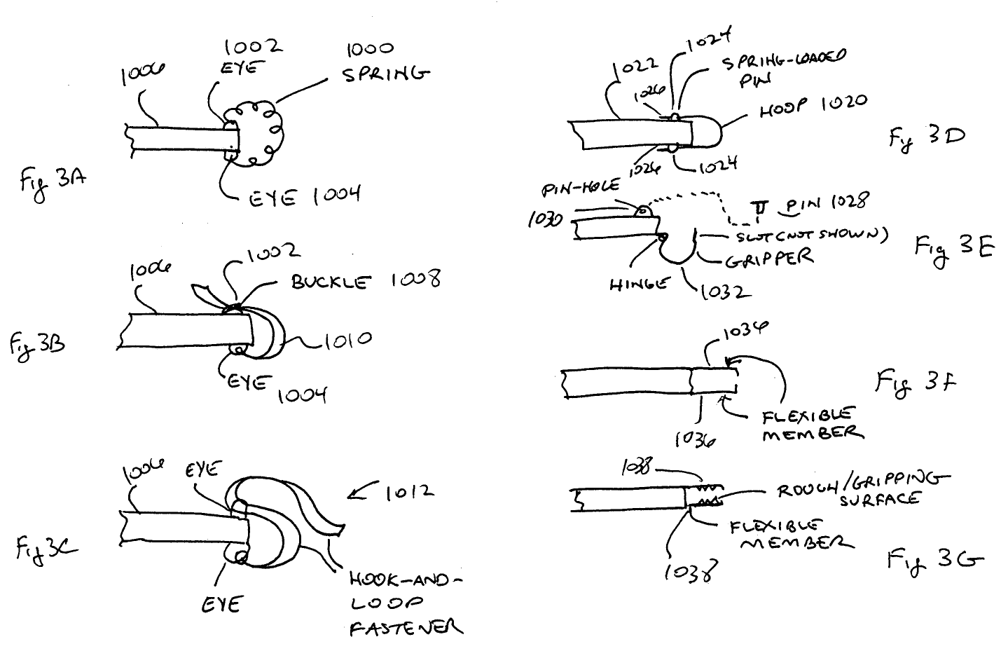

FIGS. 3A-3G show some of the embodiments of the grip. FIG. 3A depicts a spring 1000 that is affixed to an eye 1002 and is reversibly joinable to a second eye 1004. In use, the spring 1000 is passed around the medical device, e.g., i.v. pole 1006 , and secured to one of the eyes. FIG. 3B depicts a buckle 1008 that may be used with a strap 1010 to buckle the i.v. pole 1006. FIG. 3C depicts a hook-and-loop fastener system 1012 for gripping. FIG. 3D depicts a hoop 1020 that is securable to the extension 1022 by use of biased pins 1024 and slots for the pins 1026. FIG. 3E depicts a rigid pin 1028 that may be used with a slot and a pin-hole for gripping 1030 with gripper 1032. FIGS. 3F and 3G depicts flexible member(s) 1036, 1038 that are on the extension. The medical device is pushed into the flexible members 1036, 1038 so that they are forced open and resiliently grip the device. The grip of the flexible members 1036, 1038 may be enhanced, e.g., by using a gripping material inside the flexible members, e.g., a soft, sticky, or rigid material. A preferred embodiment is the rough surface found on a pipe wrench favored by plumbers. Combinations and variations of these schemes for gripping may also be used.

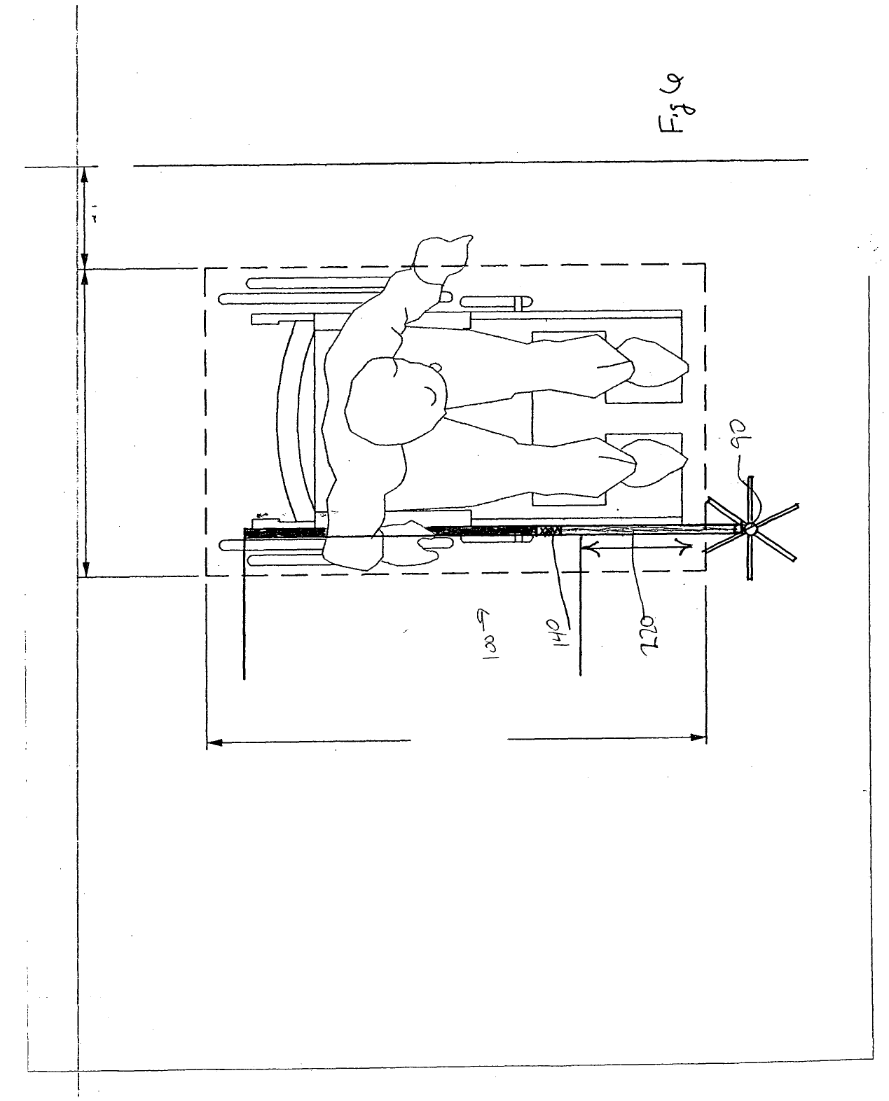

FIG. 7 depicts a wagon having a transporting pole mounted thereto Main body 120 is secured to the underside of the wagon and holder 140 is secured about extension 110. Grip 230 is secured to i.v. pole 90. The pole is preferably mounted to follow the wagon so as to provide the least obstacle to the user pulling the wagon.

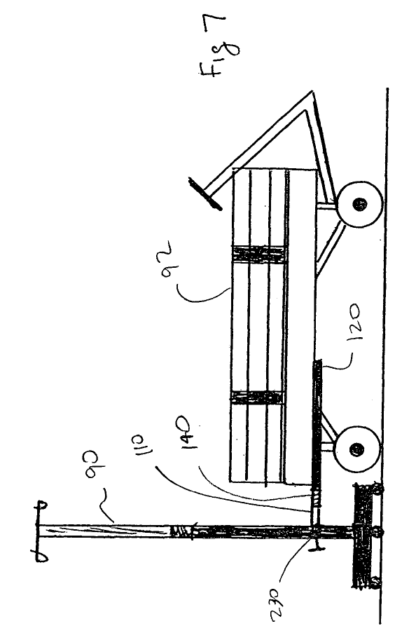

FIG. 8 depicts a preferred embodiment having clamp 500 with a clamp-type grip 502 that is secured by bolt 504. The extension 506 is in the stowed position and is secured by holder 508. The extension is further stowed and secured to the main body using biased pins 510 that are received by slots 512. The grip 502 is preferably mounted on a removable extension portion 514 that is reversibly attached to the extension 506. The removable extension portion 514 is secured to main body 516 using biased pins 510 that are received by slots 512. An optional strap 518 for securing the clamp is also depicted. FIG. 8 further depicts an optional cap 520 for covering the end of the extension 506 after the removable extension portion 514 has been removed. The cap may be used for safety purposes.

Referring to FIG. 8, in use, the extension 506 is stowed in the main body 516 by pushing the extension 506 into the main body 516. A biased pin 510 moves up into a pin-receiving slot 512 to secure the extension 506. The holder 508 is secured to the main body 516 as needed. The removable extension portion 514 is removed from the extension 506 by depressing the pins 510 and pulling the removable extension portion 514. A cap 520 is secured over the end of the extension.

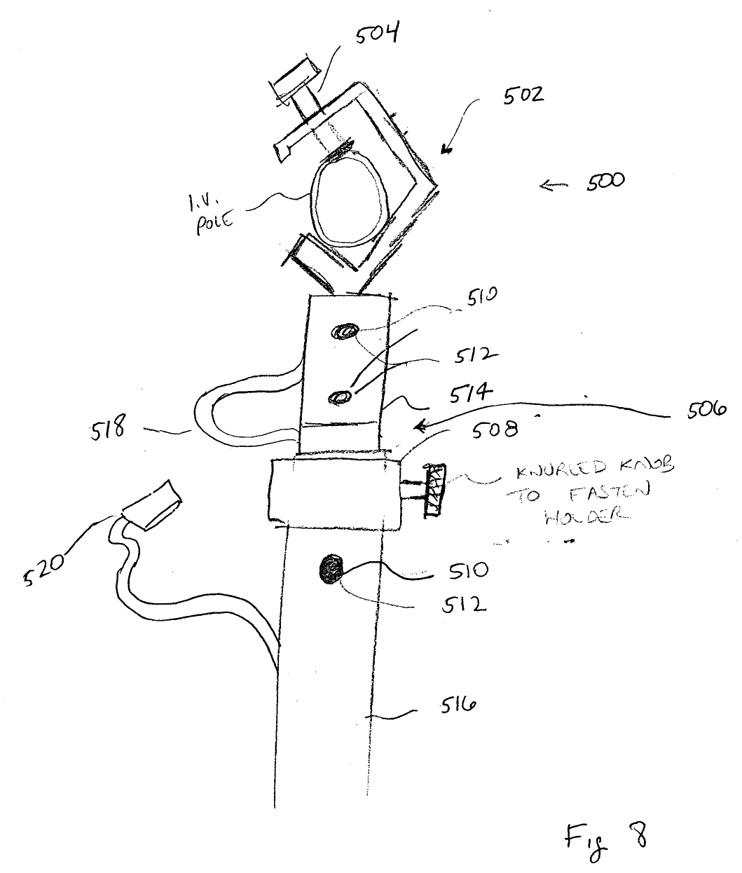

Referring to FIG. 9, a transporting pole 550 may be secured to a transport, e.g., a wheelchair 552 using a fastener 554 (e.g., a clamp) on wheelchair arm 553. The transporting pole 550 may be attached to, for example, i.v. pole 555, using grip 560. Transporting pole 550 may be secured in a first position 556 or a second position 558, or positions therebetween, as depicted by pole 550 and i.v. pole 555 being shown in broken lines. Movement between the positions changes the relative distance between the wheelchair 552 and the i.v. pole 555 or other medical device. Bias pins 562 secure extensible portion 564 to main body 566.

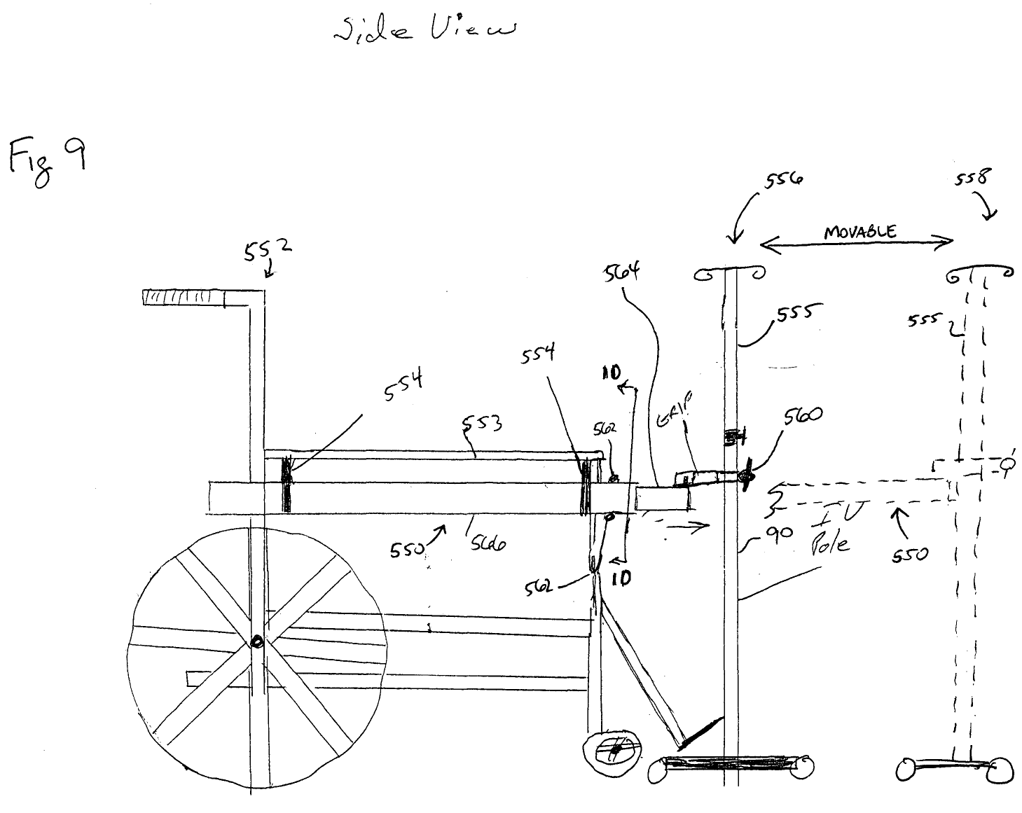

Referring to FIG. 10, a transporting pole main body 566 may be mounted to wheelchair arm 553 so as to allow lateral movement relative to the arm. This change of position is advantageous when extra lateral room is required, e.g., as in a patient that is relatively large compared to other persons that use the chair. Thus the lateral area advantageously allows for the device to be used without interfering with the patient's leg movement. Thus fastener 554 is pivotable about arm 553 from a first position 570 to a second position 572; FIG. 10A shows the second position 572 in broken lines, and FIG. 10B shows first position 570 in broken lines.

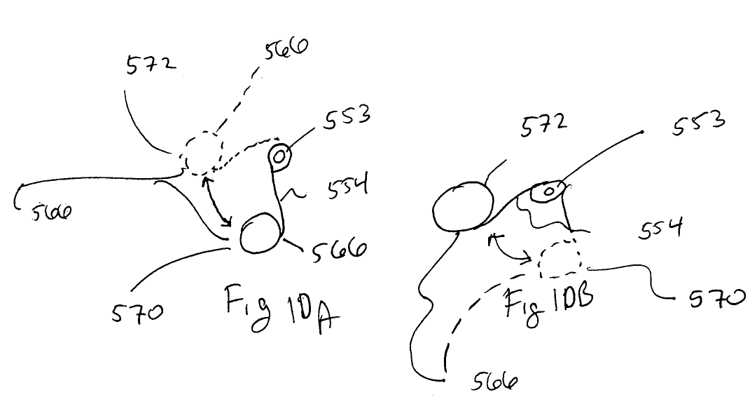

Referring to FIG. 11, a portion of the extension 595 having the gripper 596 that grips an i.v. pole is detachable from the main body and may be stored separately, e.g., on the back of wheelchair 590 having a wheelchair back 592 and wheelchair arm 594. Other storage includes on the sides, front, or underside of the wheelchair, wagon, or other transport. The reversibly detachable portion may have various sizes to accommodate its stowage, for example, it may have a maximum length (i.e., its maximum dimension) of, e.g., less than about 24, 20, 18, 16, 12, 10, 8, 6, or 4 inches. It may further have fasteners for fastening to a medical device, e.g., a wheelchair. The medical device may also have a receptacle fro receiving the detachable portion, e.g., a pocket.

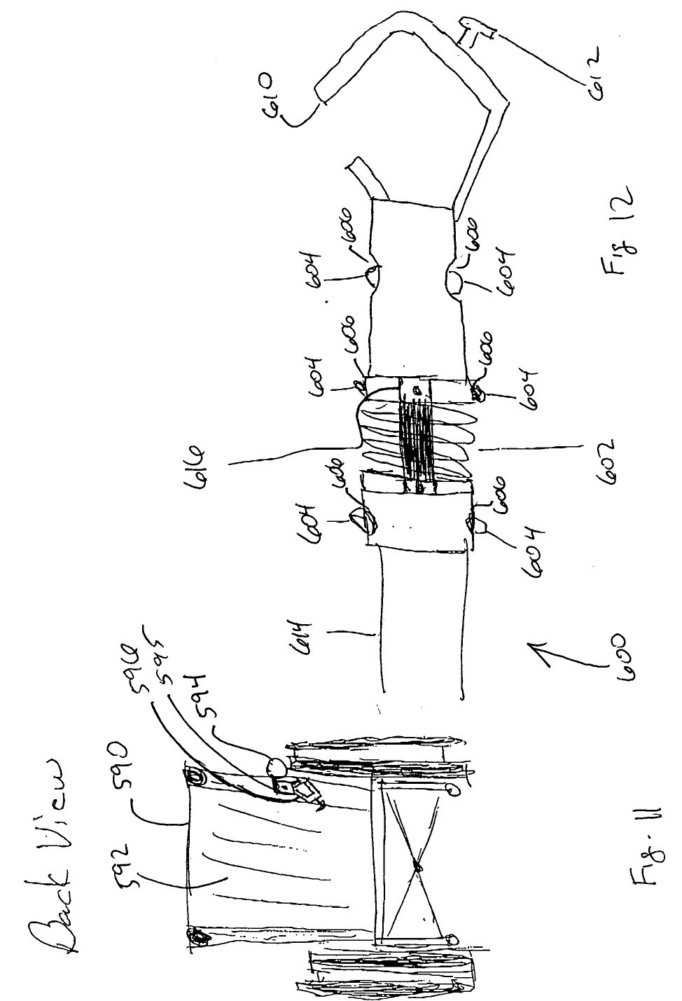

Referring to FIG. 12, a flexible member, e.g., a spring 602, may be introduced into the transporter pole 600. For example, the flexible member may be positioned close to the gripping member as a detachable member using biased pins 604 received by slots 606. Clamp 610, movable fastener 612, and arm 614 are also depicted. Optional straps 616 are also depicted that secure on either side of spring 602. The flexible member aids in the movement of the i.v. pole across unevenly graded surfaces and up and down ramps, steps, and other surfaces. Other flexible members include flexible pipes, pinioned structures, pivotable members, and hinged and segmented members. Suitable materials include plastics and metals.

Transportation devices that may be used with the transporting pole include wheelchairs and gurneys. Other medical devices include beds, rolling tables, carts, and other movable devices that support or transport patients. The term rod, as used herein, refers to an article that may be, e.g., cylindrical, solid, hollow, polygonal in cross-section, or square in cross-section.

Suitable materials for the transporting pole, including the holders, grips, main body, and extension, include: metals, iron, stainless steel, steel, aluminum, bronze, alloys, titanium, and plastics, including polyethylene, polypropylene, polybutadiene, polycarbonate, fluorocarbons, polystyrene, and ABS plastics. Materials that are free of latex and natural rubber are favored since these materials are allergenic. Materials that are easy to wipe-down for sanitary purposes are favored.

The embodiments of the invention described herein are for exemplary purposes only and are not intended to limit the scope and spirit of the invention.

### References

Aspects of designing various members of the transporting pole will be understood by those skilled in these arts after reading this disclosure. The following patents and patent applications are hereby incorporated herein by reference: U.S. Pat. Nos. 6,428,029; 6,354,390; 6,179, 260; 5,482,239; 5,374,074; 5,366,191; 5,135,191; 4,949,408; 4,725,027; 4,572,536; 4, 451,158; 4,511,157; and 4,840,391. Some suitable locking mechanisms for use in with embodiments disclosed herein include those in, e.g., U.S. Pat. Nos. 5,220,707; 4,993,101; 5,288,161; 4,662,771; 3,603,623; and 3,596,946. All patents and publications listed herein are hereby incorporated by reference herein.

1. A transporting pole comprising an extensible member, a fastener for fastening the member to a first device for transporting patients, and grip for fastening the member to a second device that is to be transported in association with the first medical device for transporting patients, with the extensible member being movable from a first position to a second position to thereby change a distance between the first device and the second device.

2. The transporting pole of claim 1 wherein the first medical device is a wheelchair or a gurney.

3. The transporting pole of claim 2 wherein the grip is affixed to a removably detachable portion of the extensible member that is adapted to be stowed on a wheelchair.

4. The transporting pole of claim 3 wherein the removably detachable portion has a maximum length of less than about 12 inches.

5. The transporting pole of claim 4 wherein the transporting pole does not project beyond a tip of a footrest of a wheelchair when the transporting pole is fastened to the wheelchair and the removably detachable portion is detached from the transporting pole.

6. The transporting pole of claim 5 further comprising a flexible member that is flexible as the second medical device is moved relative to the first medical device.

7. The transporting pole of claim 2 wherein the grip, when not attached to the wheelchair or gurney, is detachable from the transporting pole and is stowable in a stowed position.

8. The transporting pole of claim 7 wherein the extensible member is extendible to an extended position that projects beyond a tip of a footrest of a wheelchair.

9. The transporting pole of claim 2 wherein the transporting pole is pivotably fastenable to the first medical device.

10. The transporting pole of claim 9 wherein the first medical device is a wheelchair having a wheelchair arm, and the transporting pole is pivotably fastened to the wheelchair arm so that the transporting pole is movable from a stowed position to a laterally extended position while maintaining an orientation that is substantially parallel to the wheelchair arm.

11. The transporting pole of claim 1 wherein the second device is an i.v. pole.

12. The transporting pole of claim 1 wherein the grip comprises a spring that is wrappable around the second medical device to thereby secure the second medical device.

13. The transporting pole of claim 1 further comprising a flexible member that is flexible as the second medical device is moved relative to the first medical device.

14. The transporting pole of claim 1 wherein the second medical device comprises a rod, and the grip comprises a hinged grip member that is securable about the rod by use of a pin.

15. The transporting pole of claim 1 wherein the second medical device comprises a rod, and the grip comprises an adjustable clamp that may be adjusted to grip the rod.

16. An article for transporting a patient in conjunction with a medical device, the article comprising a wagon, a transporting pole comprising an extensible member, a fastener that fastens the member to the wagon, and a grip that fastens the extensible member to a second device that is to be transported in association with the first medical device for transporting patients.

17. The article of claim 16 wherein the second device is an i.v. pole.

18. A method of transporting an i.v. pole, the method comprising attaching a transporting pole to the i.v. pole using a fastener, and attaching the transporting pole to a device for transporting patients using a grip, with the transporting pole comprising an extensible member for altering the distance between the i.v. pole and the device of transporting patients.

19. The method of claim 18 wherein the device for transporting patients is a wheelchair or wagon.

20. The method of claim 19 wherein the grip is affixed to a detachable portion of the transporting pole and the detachable portion is detached from the transporting pole and the i.v. pole and the detachable portion is stowed on the wheelchair or wagon.
